(19) United States
(12) Patent Application Publication
(10) Pub. No.: US 2012/0020091 A1
(43) Pub. Date: Jan. 26, 2012

(54) HIGH POWER WIDE COVERAGE LIGHT REFLECTION LAMP SEAT

(76) Inventor: Chia-Mao Li, Taipei (TW)

(21) Appl. No.: 12/841,179

(22) Filed: Jul. 22, 2010

(51) Int. Cl. F21V 29/00; F21V 7/00

(52) U.S. Cl. 362/294; 362/296.01

(57) ABSTRACT

A high power wide coverage light reflection lamp seat, comprises a reflecting cup opened at a lower side and an upper side thereof, inner lateral sides of the reflecting element being formed with high reflectivity surfaces; the upper side of the reflecting cup being formed with inclined light guiding edge surfaces; two deflection bodies being cross the upper side the light guiding edge surfaces; each deflection body being formed with a plurality of different inclined surfaces; the deflection bodies serving to deflect light passing therethrough; and a reflecting element installed within the reflecting cup; an outer side of the reflecting cup being formed with curved surfaces.

### FIELD OF THE INVENTION

The present invention relates to lamp seats with inclined light guiding edge surfaces so that light emitting from the lamp seat can be distributed effectively and thus the whole emission coverage is more uniform and wider.

### BACKGROUND OF THE INVENTION

In the prior art lamp, an LED lamp has a reflecting cup for reflecting light from LED. The reflecting cup causes light not to be concentrate at the central part and thus has a more uniform distribution. However, the prior art designs cause light can be reflected back and thus light coverage is narrow. Power efficiency is low.

### SUMMARY OF THE INVENTION

Accordingly, the object of the present invention is to provide a lamp seat with inclined light guiding edge surfaces so that light emitting from the lamp seat can be distributed effectively and thus the whole emission coverage is more uniform and wider.

To achieve above object, the present invention provides a high power wide coverage light reflection lamp seat, comprising: a reflecting cup opened at a lower side and an upper side thereof, inner lateral sides of the reflecting element being formed with high reflectivity surfaces; the upper side of the reflecting cup being formed with inclined light guiding edge surfaces; two deflection bodies being cross the upper side the light guiding edge surfaces; each deflection body being formed with a plurality of different inclined surfaces; the deflection bodies serving to deflect light passing therethrough; a reflecting element installed within the reflecting cup; an outer side of the reflecting cup being formed with curved surfaces.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is an exploded view of the present invention.

FIG. 3 is a schematic cross section view of the present invention.

FIG. 4 is a perspective view showing another embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

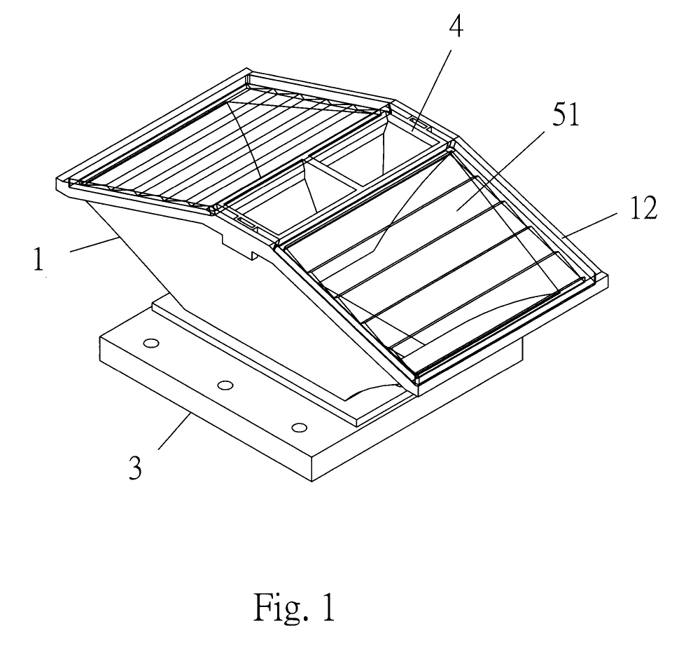

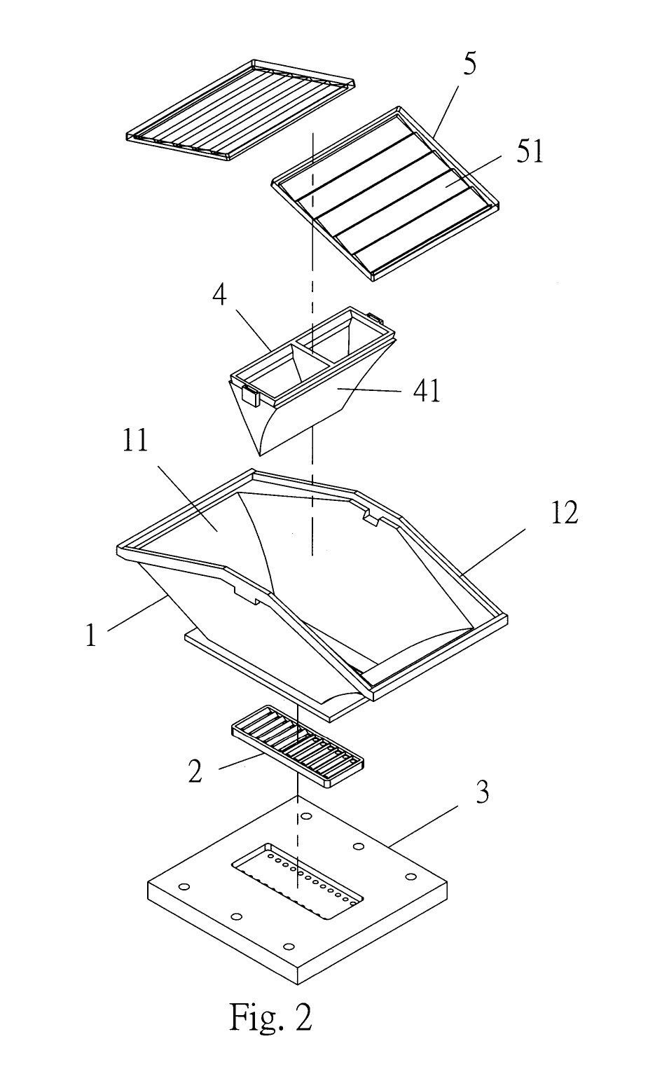

With reference to FIGS. 1 and 2, the high power wide coverage reflecting seat of the present invention includes the following elements.

A reflecting cup 1 is opened at a lower side and an upper side thereof. Inner lateral sides of the reflecting element 4 are formed with high reflectivity surfaces 11. The upper side of the reflecting cup 1 is formed with inclined light guiding edge surfaces 12.

At least one deflection body 5 (in this embodiment, two bodies are shown) is installed to run cross the upper side the light guiding edge surfaces 12. Each deflection body 5 is formed with a plurality of different inclined surfaces 51. The deflection bodies serve to deflect light passing therethrough.

In application, LEDs lamps are installed within the reflecting cup 1.

A reflecting element 4 is installed within the reflecting cup 1. An outer side of the reflecting cup 1 is formed with curved surfaces 11.

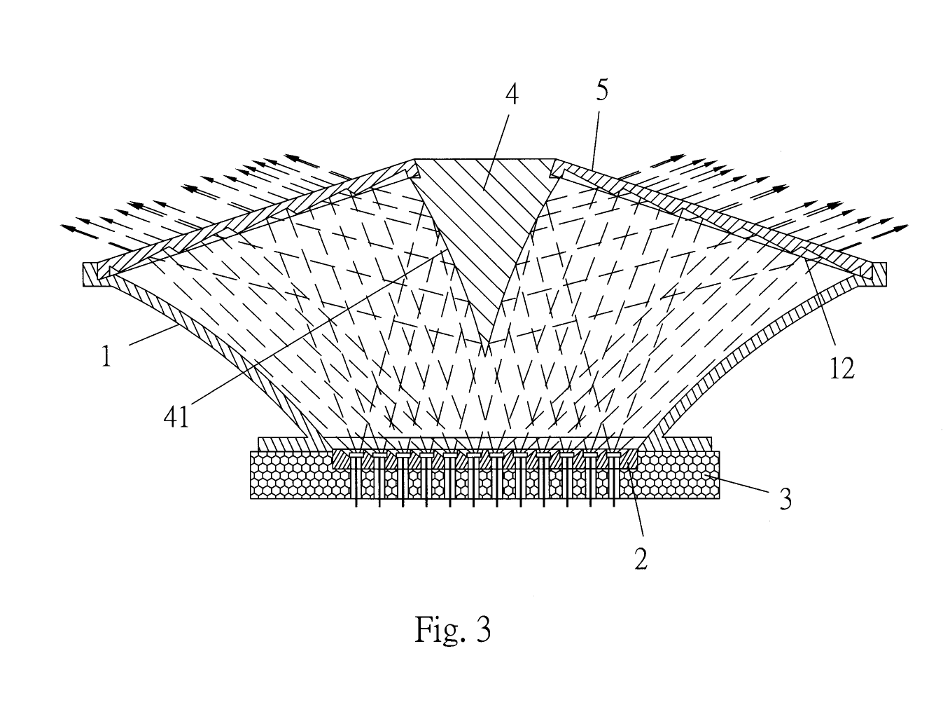

A metal heat sink body 2 is installed at the lower side of the reflecting cup 1. Referring to FIG. 3, the light sources (such as LEDs (light emitting diodes) are placed upon the metal heat sink body 2). The metal heat sink body 2 has a plurality of through holes for locating conductive wires for the light sources.

A heat conductive base 3 is installed below the metal heat sink body 2 for supporting the metal heat sink body 2 and guiding heat out of the metal heat sink body 2. The heat conductive base 3 has a plurality of through holes for locating the conductive wires extending from the light sources.

As illustrated in FIG. 3, a part of light from the light source is reflected by the reflecting element 4 to be incident toward the deflection bodies 5. Thus it will prevent that the light from concentrating in the center part of the lamp. Furthermore, in the present invention, the light guiding edge surfaces 12 causes that the deflection angle of the incident light is very small than the critical angle for reflecting incident light. Thus most of light will pass through the deflection bodies 5. Transmission lose is reduced to a very small value.

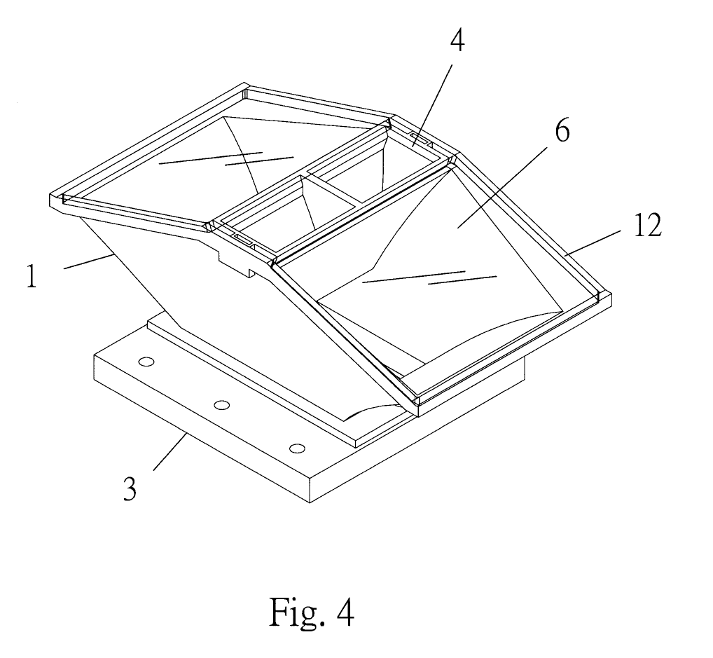

With reference to FIG. 4, another embodiment of the present invention is illustrated. The embodiment illustrated in FIG. 4 is similar to that disclosed in FIG. 1, while the deflection bodies 6 have a deflection angle of zero.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A high power wide coverage light reflection lamp seat, comprising:
a reflecting cup opened at a lower side and an upper side thereof, inner lateral sides of the reflecting element being formed with high reflectivity surfaces; the upper side of the reflecting cup being formed with inclined light guiding edge surfaces;
at least one deflection body locating cross over the upper side the light guiding edge surfaces; each deflection body being formed with a plurality of different inclined surfaces; the deflection bodies serving to deflect light passing therethrough; and
a reflecting element installed within the reflecting cup; an outer side of the reflecting cup being formed with curved surfaces.

2. The lamp seat of claim 1, further comprising:
a metal heat sink body installed at the lower side of the reflecting cup, light sources are placed upon the metal heat sink body; the metal heat sink body having a plurality of through holes for locating conductive wires for the light sources; and
a heat conductive base installed below the metal heat sink body for supporting the metal heat sink body and guiding heat from the metal heat sink body; the heat conductive base having a plurality of through holes for locating the conductive wires extending from the light sources.

3. The lamp seat of claim 1, wherein the reflecting cup has high reflectivity surfaces.
